(19) United States
(12) Patent Application Publication
(10) Pub. No.: US 2025/0362424 A1
(43) Pub. Date: Nov. 27, 2025

(54) SELF-ADJUSTABLE AIR CHAMBER FOR DOWNHOLE SONIC SHIELDING

(71) Applicant: Halliburton Energy Services, Inc., Houston, TX (US)

(72) Inventors: Jing JIN, Singapore (SG); Chung Chang, Houston, TX (US); Gary Wayne Kainer, Tomball, TX (US); Keith Bellman, Houston, TX (US)

(73) Assignee: Halliburton Energy Services, Inc., Houston, TX (US)

(21) Appl. No.: 18/978,553

(22) Filed: Dec. 12, 2024

Related U.S. Application Data
(60) Provisional application No. 63/651,092, filed on May 23, 2024.

(51) Int. Cl. G01V 1/52

(52) U.S. Cl. CPC G01V 1/523

(57) ABSTRACT

Described herein are systems and techniques for improving the accuracy of determinations made using sensed data. Sensors used to collect acoustic data may collect unwanted noises when collecting data useful for a given purpose. Since unwanted noises may reduce the signal to noise ratio (SNR) of a sensing system, these unwanted noises can reduce the reliability of determinations made by the sensing system. Sensors of the present disclosure may include a chamber that may be filled with gas or be configured to resist pressures that exist in wellbore. Differences in acoustic transmission coefficients and shapes used to build the sensor may attenuate noise that propagates from certain directions. Sensing devices of the present disclosure may be used to attenuate noise from one direction while passing and sensing sounds that propagate from another direction.

### CROSS-REFERENCE TO RELATED APPLICATIONS

This application claims priority benefit of U.S. Provisional Patent Application No. 63/651,092 filed May 23, 2023, which is incorporate herein by reference.

### TECHNICAL FIELD

The present disclosure is generally directed to improving operation of a sensor or sensing apparatus. More specifically, the present disclosure is directed to increasing the signal to noise ratio of a sensor.

### BACKGROUND

A wellbore or borehole is a hole that is drilled in the ground, often for the purpose of extracting substances (e.g., oil, natural gas, or water) or to provide substances into subterranean structures (e.g., carbon dioxide or hydraulic fracturing fluids). During virtually any phase of wellbore development, acoustic sensors may be used to collect data from which various determinations may be made. No matter what application an acoustic sensing system is applied to, unwanted noise associated with the wellbore environment may taint sets of collected data. This may increase the probability that determinations made by a sensing system using the collected data will be error prone.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology.

FIG. 1B is a schematic diagram of an example downhole environment having tubulars, in accordance with various aspects of the subject technology.

FIG. 2 illustrates a structure that resists compression when that structure is exposed increased environmental pressure, in accordance with various aspects of the subject technology.

FIG. 3 illustrates a sensor disposed in a structure that may make the sensor operate as a directional sensor, in accordance with various aspects of the subject technology.

FIG. 4 illustrates an element that may transmit acoustic energy (sound waves) when an active acoustic sensing apparatus operates, in accordance with various aspects of the subject technology.

FIG. 5 illustrates an acoustic device that could act as a directional acoustic sensor, acoustic transmitter, or both, in accordance with various aspects of the subject technology.

FIG. 6 illustrates an acoustic device that could act as a directional acoustic sensor, acoustic transmitter, or both, in accordance with various aspects of the subject technology.

FIG. 7 illustrates an acoustic device that could act as a directional acoustic sensor, acoustic transmitter, or both, in accordance with various aspects of the subject technology.

FIGS. 8A and 8B respectively illustrate a semi-cross-sectional top view and a perspective view of an acoustic device that allows acoustic energy to pass toward a sensing element in one direction only.

FIG. 9 illustrates two additional structures that resist compression when those structures are exposed to an increased environmental pressure, in accordance with various aspects of the subject technology.

FIG. 10 illustrates actions that may be taken when a sensing device is deployed in a wellbore, in accordance with various aspects of the subject technology.

FIG. 11 illustrates an example computing device architecture which can be employed to perform any of the systems and techniques described herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous compounds. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings arc not necessarily to scale and the proportions of certain parts may be exaggerated to better illustrate details and features. The description is not to be considered as limiting the scope of the present disclosure.

Acoustic sensors or hydrophones deployed in a wellbore are used to collect data that may be analyzed to identify properties of subterranean strata and/or manmade subterranean strata. For example, subterranean strata may include one or more different types of materials such as include granite, sandstone, basalt, water, oil, or natural gas. Examples of manmade subterranean structures include casings that may be cemented into place in a hole drilled into subterranean strata and tubing that may be deployed in a casing. Terms used to refer to such holes or structures built into such holes include well, borehole, and wellbore. Data sensed by the acoustic sensors may be evaluated to identify types of rock that are located at different areas of a borehole, may be used to identify where fluids are flowing through subterranean strata, and may be used to identify the structural integrity of a manmade wellbore structures. In certain instances, acoustic data may be collected using active or passive data collection techniques. Active acoustic sensing techniques transmit acoustic energy (sound waves) and receive reflections of transmitted acoustic energy. Examples of active acoustic sensing include ultrasound imaging systems and sonar. Active acoustic sensing may be used to identify types of rock surrounding a borehole or may be used to identify the porosity or permeability of subterranean rock structures.

Passive acoustic sensing techniques sense sound without relying on a transmitter to transmit acoustic energy. As such, passive acoustic sensing techniques listen to sounds generated by a source that is not part of a sensing system. When an acoustic sensor is deployed in a borehole, it may sense sounds generated when subterranean fluids move through strata of the Earth and may sense sounds that could be indicative of a wellbore defect. Passive acoustic sensing may be used to listen for fluid leaks. For example, passive acoustic sensing may be used to detect defects in cement that holds a casing in place or may be used to identify whether a wellbore casing or tube is leaking.

Sensors used to collect acoustic data may also collect unwanted noises and these unwanted noises may reduce the signal to noise ratio (SNR) of a sensing system. Unwanted noise can reduce the reliability of determinations made by a sensing system because this unwanted noise obfuscates, or masks sounds from which determinations about a wellbore may be made. As such, described herein are systems, apparatuses, processes (also referred to as methods), and computer-readable media (collectively referred to as “systems and techniques”) for improving an accuracy of sensed data and determinations made using that data. Examples of the systems and techniques described herein are illustrated in the figures that follow.

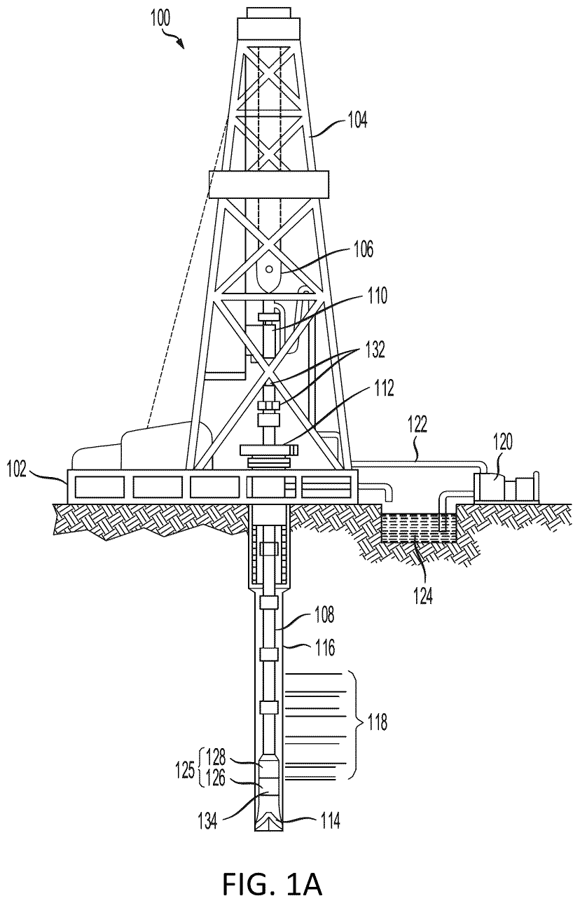

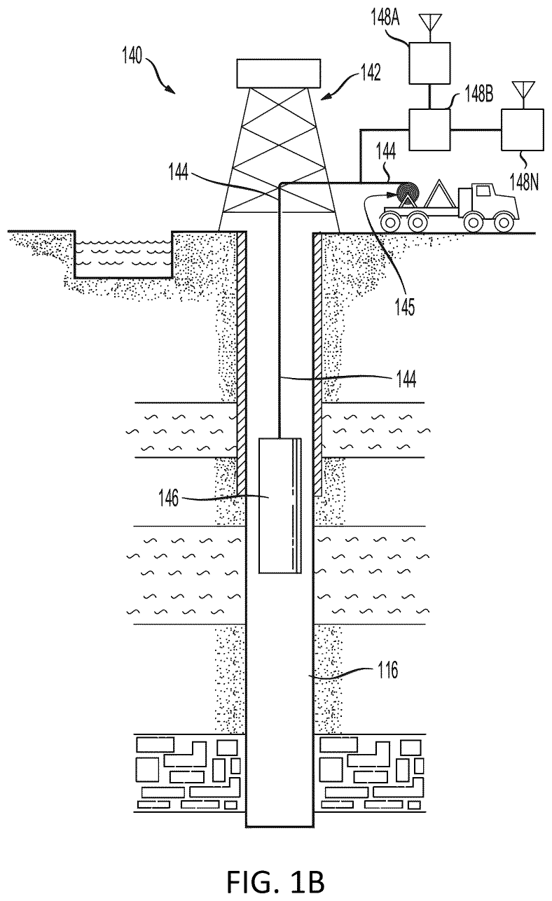

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seismic sensors, gravity sensor, image sensors, etc.) that can acquire formation data, such as characteristics of the formation, components of the formation, etc. For example, the drilling arrangement shown in FIG. 1A can be used to gather formation data through an electromagnetic imager tool (not shown) as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. An electromagnetic imager tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via wireline conveyance 144 to meet power requirements of the tool. For slickline or coiled tubing configurations, power can be supplied downhole with a battery or via a downhole generator.

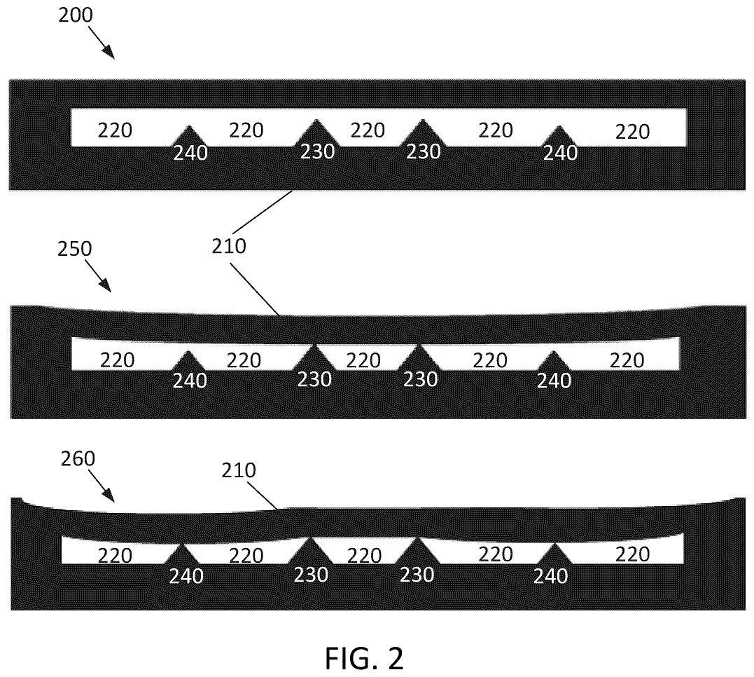

FIG. 2 illustrates a structure that resists compression when that structure is exposed increased environmental pressure. FIG. 2 includes three images of the same structure 210. Image 200 illustrates structure 210 when it is exposed to a first pressure, image 250 illustrates structure 210 when it is exposed to a second pressure, and image 260 illustrates structure 210 when it is exposed to a third pressure. Here the second pressure may be greater than the first pressure and the third pressure may be greater than the second pressure. Each of these images shows area/chamber 220 located within structure 210. When chamber 220 is filled with a gas (e.g., air or nitrogen) the structure may be flexible because gasses may be compressed when exposed to increasing pressures. As such, chamber 220 may be referred to as a gas cavity, a chamber, or a cavity. Structure 210 of FIG. 2 includes several triangular shaped features 230 and 240. Triangular shaped features 230 are taller than triangular shaped features 240. When structure 210 is exposed to increased pressure, structure 210 begins to compress. As this pressure increases, chamber 220 within structure 210 reduces. This increased pressure may cause structure 210 to collapse or bend. When exposed to enough pressure, triangular shaped features 230 will act as supports that will tend to prevent structure 210 from collapsing entirely, image 250 of FIG. 2 shows this. In instances when structure 210 is exposed to yet higher pressure, structure 210 may compress until triangular features 240 also prevent structure 210 from collapsing as illustrated in image 260.

Gasses (e.g., air or nitrogen) do not transmit sound as efficiently as solids or liquids do. As such it can be said that chamber 220 may not transmit sound as efficiently as solid parts of structure 210. This means that chamber 220 may be used as a shield to protect an acoustic sensor from receiving unwanted noise. In certain instances, instead of being filled with gas, all or some portion of gas may be removed from chamber 220. In other instances, chamber 220 may filled with gas at a pressure that is greater than atmospheric pressure. Materials or structures (e.g., chambers that include structural support features) that are used to attenuate or block acoustic energy (e.g., gases or other acoustic damping material) may be referred to as acoustic shields or acoustic shielding. Materials or structures that allow acoustic energy to pass through more efficiently (e.g., some solid or liquid materials) than the aforementioned acoustic shielding materials may be referred to as acoustic transmission mediums. In certain instances, acoustic transmission mediums of the present disclosure may include fluid filled chambers.

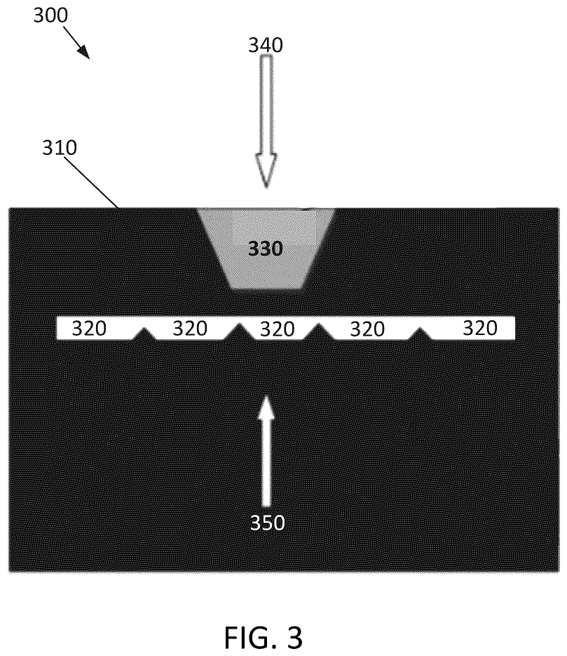

FIG. 3 illustrates a sensor disposed in a structure that may make the sensor operate as a directional sensor. Sensor 300 includes structure 310, sensing element 330, and chamber 320. Chamber 320 includes the same triangular shaped features as features 230 and 240 of FIG. 2, yet hear these triangular features are not numbered. FIG. 3 also includes sound waves 340 and 350, where sound waves 340 move from above sensing element 330 and where sound waves of noise 350 move through structure 310 toward chamber 320 and sensing element 330. Sensor 300 of FIG. 3 may sense sound waves 340 more efficiently than sound waves of noise 350 for at least two reasons. One of these reasons is the shape (e.g., trapezoidal shape) of sensing element 330 and the other reason is that chamber 320 will tend to attenuate noise 350 before it reaches sensing element 330. Since sensing element 330 has a larger surface facing sound waves 340 and because sound waves 340 do not have to move through chamber 320 before reaching sensing element 330, sensing element 330 will sense sound waves 340 more efficiently than sound waves of noise 350. Noise 350 may be attenuated by chamber 320 and as such noise propagating from one side (e.g., the bottom side) of sensing element 330 may be attenuated based on chamber 320 being disposed between a noise source located below sensor 300. Sound waves 340 may not be attenuated very much at all as sound waves 340 may only have to propagate though a portion of structure 310. This means that sound waves of noise 350 will be attenuated based on a first energy transfer coefficient and sound waves 340 will propagate to sensing element 330 based on a second energy transfer coefficient.

When the sensor 300 is deployed in a wellbore, noise 350 may represent sound generated by a tool (e.g., an ultrasonic transmitter in the tool). Because of this, sensor 300 may increase the SNR of sound sensed by sensing element 330 in one direction (e.g., from above sensor 300) while reducing the SNR of sound sensed by sensing element 330 in another direction (e.g., from below sensor 300). For these reasons, sensors of the present disclosure may remove tool noise generated in a wellbore more efficiently as compared to other sensors. Acoustic energy of noise 350 moving from below sensor 300 may be attenuated more than acoustic energy of sound waves 340. Acoustic energy (sound waves) moving from above sensor 300 may pass to sensing element 330 with little to no attenuation or in some instances, the shape of the acoustic sensor 300 or sensing element 330 may focus acoustic energy. Sound waves 340 traveling from above sensor 300 may either pass to sensing element 330 without attenuation, with some amount of attenuation, or with a gain (increased energy). Noise 350 traveling from below sensor 300 will be attenuated based on the presence of chamber 320 and based on structure of sensor 300. This means that acoustic energy/noise 350 traveling from below sensor 300 will be attenuated according to a first coefficient (a first energy transfer coefficient). Since acoustic energy of sound waves 340 traveling from above sensor 300 may pass to sensing element 330 with little to no attenuation or a gain, the acoustic energy of sound waves 340 may be characterized as propagating to sensing element 330 according to a second coefficient (a second energy transfer coefficient). When the structure of acoustic sensor 300 attenuates acoustic energy traveling from below sensor 300 by 95%, the first acoustic energy transfer coefficient may be 0.95. Other examples of this first coefficient are 0.90 and 0.098, respectively when the structure of the sensor 300 attenuates acoustic energy transfer by 90% and 98%. Examines of the second coefficient are 0.01, 1.0, and 1.3. Here a 0.01 value would mean that 99% of the energy traveling from above sensor 300 will move to sensing element 330. Similarly, values of 1.0 and 1.3 for the second coefficient respectively mean sound energy passes from above sensor 300 to sensing element with no attenuation (based on a 1.0 value of the second coefficient) or with a 30% gain (based on a 1.3 value of the second coefficient). For example, the trapezoidal shape of sensing element 330 may result in a gain in sensed acoustic energy from above while further attenuating acoustic energy from below sensor 300.

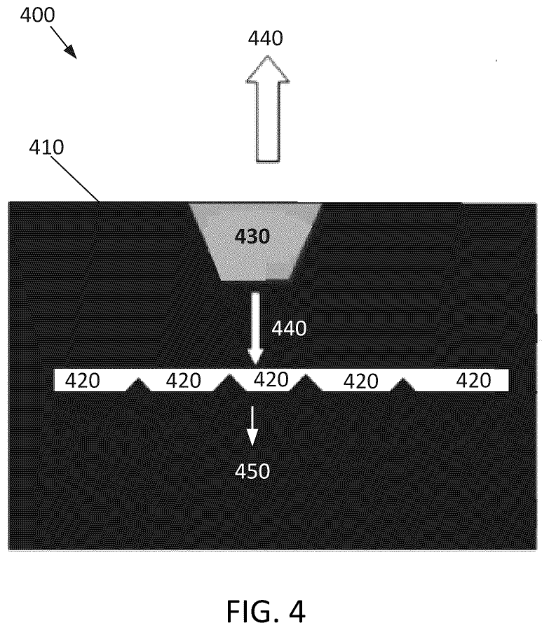

FIG. 4 illustrates an element that may transmit acoustic energy (sound waves) when an active acoustic sensing apparatus operates. Element 400 of FIG. 4 may include a transmitting element 430 that transmits acoustic energy and transmitting element 430 may be built within structure 410 that houses chamber 420. When transmitting element 430 transmits acoustic energy (here represented by arrow 440), that acoustic energy may travel more efficiently upward away from transmitting element 430 than downward away from transmitting element 430. Here again, this may be due to the shape of transmitting element 430. Note that the arrow 440 pointing up in FIG. 4 is larger than arrow 450 that points down. This larger arrow indicates that a greater magnitude (amplitude) of acoustic energy travels away from the larger part of transmitting element 430. Smaller arrow 450 indicates that a smaller magnitude of acoustic energy travels down toward chamber 420. When the sound energy reaches chamber 420, it will be attenuated further as indicated by the smallest sound energy arrow 450. Because of this, FIG. 4 illustrates a topology of a directional acoustic transmitter that focuses transmitted acoustic energy in one direction and that attenuates transmitted acoustic energy in a second direction. Acoustic chamber 420 may attenuate (or limit/prevent) acoustic energy from unwanted directions from reaching a sensor (e.g., sensor 300 of FIG. 3 or element 430 operating as a receiving element). Acoustic chamber 420 may also prevent acoustic energy from being transmitted in certain directions because of the attenuation provided by the chamber. As such, the signal to noise ratio of a sensor may be directionally optimized or tuned based on the presence and shape of one or more acoustic chambers, sensors, and/or transmitters/transceivers.

In certain instances, element 400 of FIG. 4 and sensor 300 of FIG. 3 may be the same device. In such an instance, element 400 may act as a directional transceiver. This means that the same device may act as both an acoustic transmitter and an acoustic sensor.

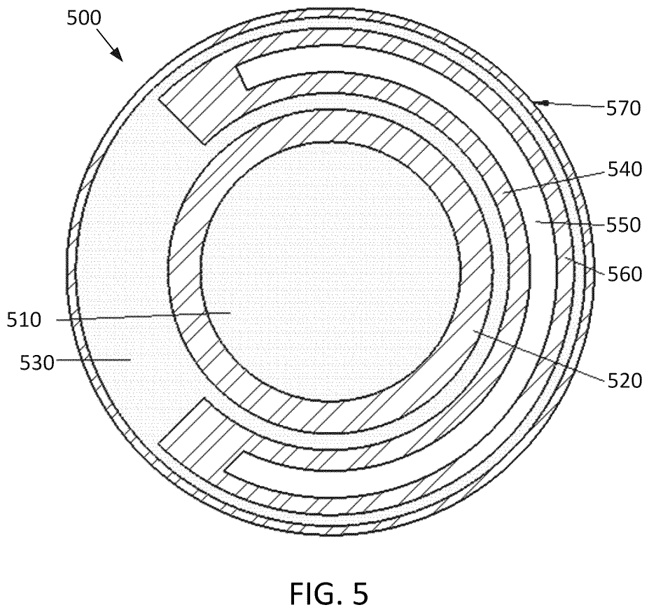

FIG. 5 illustrates an acoustic device that could act as a directional acoustic sensor, acoustic transmitter, or both. FIG. 5 illustrates acoustic device 500 that includes oil filled portions 510 and 530, piezoelectric ring 520, walls 540 and 560 that surround chamber 550, and a waterproof layer 570. For example, acoustic device 500 may be made in a circular, a cylindrical, or a spherical shape. Chamber 550 may form an acoustic shield that attenuates acoustic energy that comes from the right side of acoustic device 500. Since chamber 550 is not located on the left side of acoustic device 500, piezoelectric ring 520 is not shielded from sounds emitted from a sound source located to the left of acoustic device 500. For these reasons, acoustic device 500 may be a directional acoustic sensor.

Alternatively, or additionally, acoustic device 500 may transmit acoustic energy when acoustic device 500 is used in an active acoustic sensing application. As discussed above in respect to FIG. 4, such an acoustic transmitter will tend to be directional. Furthermore, acoustic device 500 may act as a transceiver when it both transmits and senses acoustic energy.

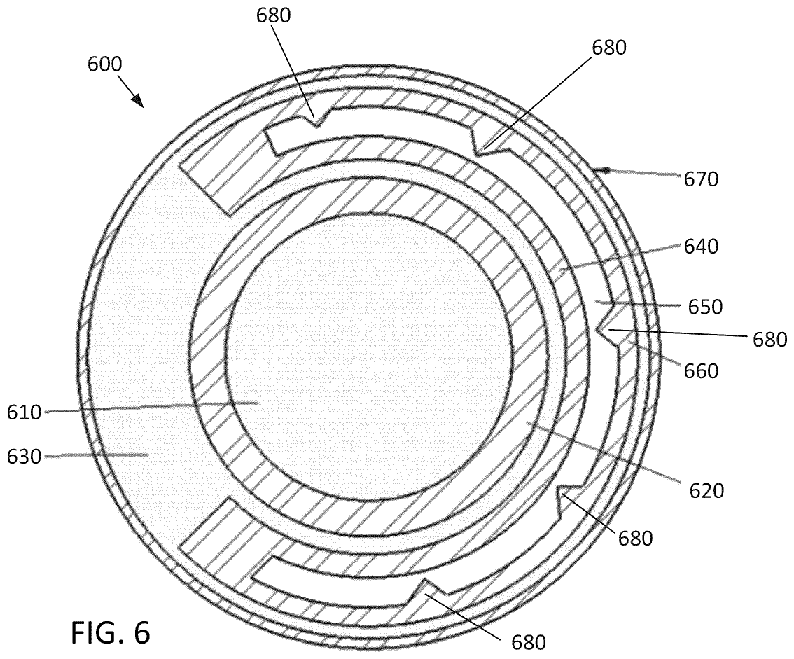

FIG. 6 illustrates an acoustic device that could act as a directional acoustic sensor, acoustic transmitter, or both. FIG. 6 illustrates acoustic device 600 that includes oil filled portions 610 and 630, piezoelectric ring 620, walls 640 and 660 that surround chamber 650, and a waterproof layer 670. Acoustic device 600 may be made in a circular, a cylindrical, or a spherical shape, for example. Chamber 650 may form an acoustic shield that attenuates acoustic energy that comes from the right side (e.g., the backside) of acoustic device 600. Since chamber 650 is not located on the left side of acoustic device 600, piezoelectric ring 620 is not shielded from sounds emitted from a sound source located to the left (e.g., the frontside) of acoustic device 600. For these reasons, acoustic device 600 may be a directional acoustic sensor.

Alternatively, or additionally, acoustic device 600, like acoustic device 500 of FIG. 5 may transmit acoustic energy when acoustic device 600 is used in an active acoustic sensing application. As discussed above in respect to FIGS. 4 and 5, such an acoustic transmitter will tend to be directional. Furthermore, acoustic device 600 may act as a transceiver when it both transmits and senses acoustic energy.

Acoustic device 600 also includes triangular shaped features 680. These features may allow chamber 650 to collapse to an extent where the tips of features 680 may contact wall 640 of acoustic device 600. When features 680 make physical contact with wall 640, chamber 650 may not collapse. As such, acoustic device 600 may be capable of withstanding greater pressures than acoustic device 500 of FIG. 5.

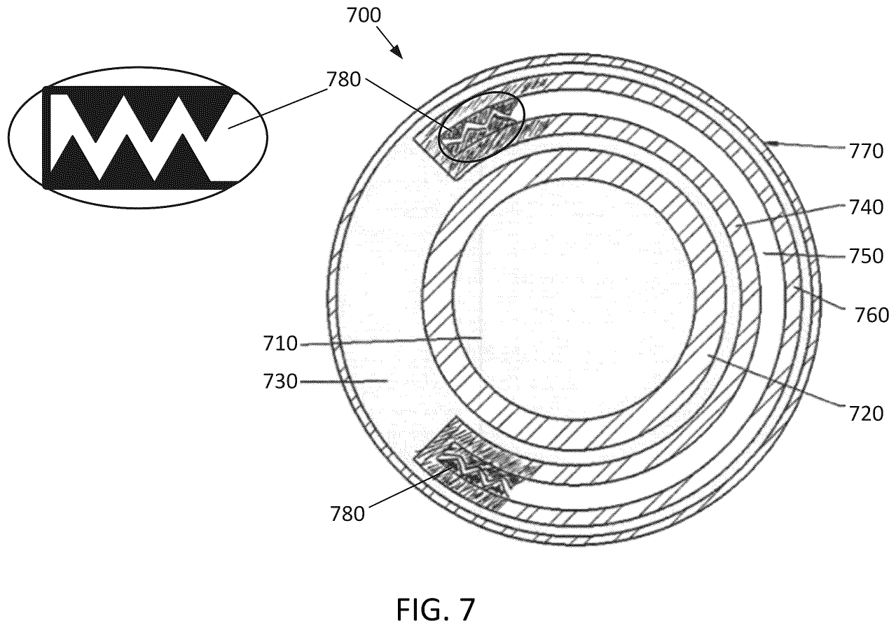

FIG. 7 illustrates an acoustic device that could act as a directional acoustic sensor, acoustic transmitter, or both. FIG. 7 illustrates acoustic device 700 that includes oil filled portions 710 and 730, piezoelectric ring 720, walls 740 and 760 that surround chamber 750, and a waterproof layer 770.

Acoustic device 700 may be made in a circular, a cylindrical, or a spherical shape, for example. Chamber 750 may form an acoustic shield that attenuates acoustic energy that comes from the right side of acoustic device 700. Since chamber 750 is not located on the left side of acoustic device 700, piezoelectric ring 720 is not shielded from sounds emitted from a sound source located to the left of acoustic device 700. For these reasons, acoustic device 700 may be a directional acoustic sensor.

Alternatively, or additionally, acoustic device 700, like the acoustic devices FIGS. 5 and 6 may transmit acoustic energy when acoustic device 700 is used in an active acoustic sensing application. As discussed above in respect to FIGS. 4 through 6, such an acoustic transmitter will tend to be directional. Furthermore, acoustic device 700 may act as a transceiver when it both transmits and senses acoustic energy.

Acoustic device 700 also includes triangular shaped features 780. These features may allow chamber 750 to collapse to an extent where the tips of features 780 may contact wall 740 of acoustic device 700. Here however, the triangle shaped features 780 are not distributed along chamber 750, they are located at the opposite ends of chamber 750. The oval shaped area on the left side of FIG. 7 is an expanded view of triangle shaped features 780.

Acoustic devices of the present disclosure may be configured to block acoustic energy coming from specific different directions depending on where materials or structures that attenuate acoustic energy are located in the devices. These acoustic devices may also be configured to pass acoustic energy to a sensing element (e.g., a piezoelectric ring) located in the devices. A first device may be configured to block or attenuate acoustic energy coming from a top side, a bottom side, and a right side of that device. In such an instance, the first device may be configured to pass acoustic energy from the left side of this first device toward a sensing element located in the first device. In such an instance, the first device may include acoustic damping materials or structures around part of the left side of the first device. Such a device may allow acoustic energy to pass through a small opening or aperture in the acoustic shielding. For example, a circular area located on the left side of the first device may allow acoustic energy to pass through much like the aperture of a camera that allows light to sine on one or more light sensitive elements within the camera.

A second device may be configured to pass acoustic energy coming from the top side and the bottom side of the second device. Acoustic energy coming from other directions (e.g., the left and right sides) of the second device may be attenuated by acoustic shielding. Acoustic shielding materials and/or structures may be arranged to attenuate acoustic energy from specific directions using the air-filled portions discussed above, using other acoustic dampening materials, or by using multiple layers of acoustic shielding of one or more types. Similarly, materials that pass acoustic energy more efficiently (acoustic transmission mediums) may be arranged in specific locations of a device to allow acoustic energy to pass to a sensing element more efficiently.

Even when an acoustic device is used to transmit acoustic energy, that acoustic device may be configured to more readily pass acoustic energy in one or more specific directions based on where acoustic dampening materials and where acoustic transmission mediums are located.

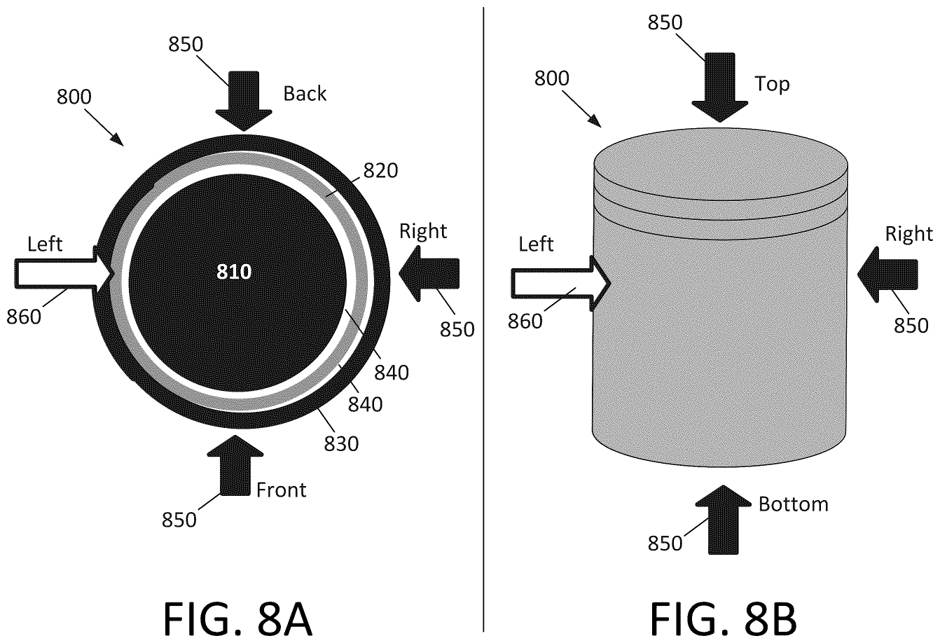

FIGS. 8A and 8B respectively illustrate a semi-cross-sectional top view and a perspective view of an acoustic device that allows acoustic energy to pass toward a sensing element in one direction only. FIG. 8A is a semi-cross-sectional top view of acoustic device 800 that may have a cylindrical shape. Here acoustic device 800 is depicted as including outer surface 830 within which are acoustic shields 840 (e.g., air or gas filled structures, other acoustic dampening material, or an area where gas has been evacuated from), sensing element 820 (e.g., piezoelectric ring), and mandrel 810 may be located. The arrangement of acoustic transmission mediums in acoustic device 800 may allow energy from acoustic waves 860 to pass through the left side of acoustic device 800, the energy from acoustic waves 860 may travel through outer surface 830 to sensing element 820 with minimal attenuation. Acoustic shields 840 may have an arrangement that blocks or attenuates energy from other directions as shown by acoustic waves 850 of FIGS. 8A and 8B. One or more other components (e.g., an amplification circuit) may be located within mandrel 810.

FIG. 8B illustrates a perspective view of acoustic device 800. Here again, acoustic device 800 may be configured to allow energy from acoustic waves 860 to pass through the left side of acoustic device 800 towards a sensing element located inside of acoustic device 800 (e.g., toward sensing element 820 of FIG. 8A). Shields located inside of acoustic device 800 block or attenuate acoustic energy/waves 850 from all sides of the acoustic device except the left side of acoustic device 800. While not depicted in FIGS. 8A and 8B, acoustic shields may be located near the “top” and “bottom” portions of acoustic device 800.

While FIGS. 8A and 8B show a cylindrical acoustic device configured to sense acoustic energy from a “left” side of acoustic device 800, acoustic devices with a cylindrical shape may be configured to sense acoustic energy from one or more other directions. In a set of examples, such an acoustic device may be configured to sense acoustic energy from any set of one or more directions while attenuating acoustic energy from another set of directions. As such, depending on how a specific acoustic device is built, acoustic energy may either be attenuated or passed via any side (left, right, front, back, top, and/or bottom side(s)) of the acoustic device.

In certain instances, an acoustic device may have one or more geometric shapes (e.g., a spherical, a cylindrical, a semi-circular, curved, or other shaped feature). Such an acoustic device may be configured to sense acoustic energy via one or more apertures built into the acoustic device. Here again, such apertures may operate like the apertures of a camera. As such, acoustic devices consistent with the present disclosure may be configured to sense or transmit acoustic energy in highly directional ways based on where acoustic shields and acoustic transmission mediums are located within a respective acoustic device.

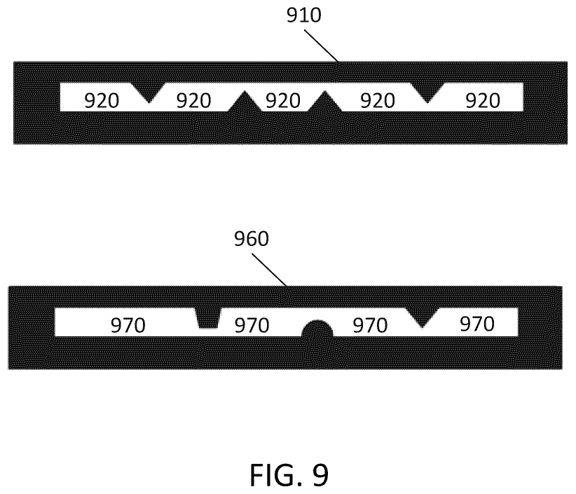

FIG. 9 illustrates two additional structures that resist compression when those structures are exposed to an increased environmental pressure. FIG. 9 includes a first structure 910 and a second structure 960. Each of these structures may act in a manner like the structure discussed in respect to FIG. 2 and may be used in the acoustic devices of FIGS. 3 through 7. Note that structure 910 includes chamber/cavity 920 and that structure 960 includes chamber/cavity 970. Note also that structure 910 includes unnumbered triangle shaped features that have triangle shaped features that point in different directions, where two point in a first direction (upward) and another two point in a second direction (downward).

Structure 960 includes features that have a trapezoidal shape, a semi-circular shape, and a triangular shape. As such gas cavities or cavities of the present disclosure may include internal features of any geometrical shape that help prevent those cavities from collapsing because of external pressure. Because of this and the cavities of different shapes discussed above, features that resist compression of a chamber may be arranged in one or more locations of the chamber in various topologies.

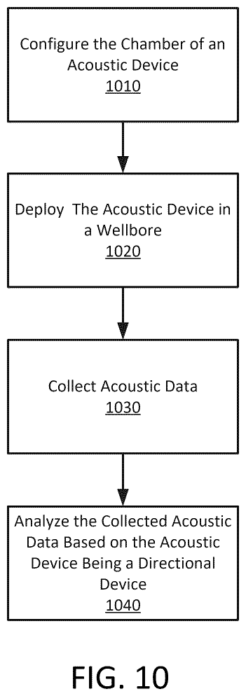

FIG. 10 illustrates actions that may be taken when a sensing device is deployed in a wellbore. At block 1010 a chamber of an acoustic device may be configured. This may include providing a gas at a chosen pressure (e.g., atmospheric pressure or other pressure) to the chamber and then sealing the chamber. Alternatively, this may include evacuating some gas from the chamber and then sealing the chamber. For example, a vacuum may be used to remove gas from the chamber. This may occur at a drilling rig or may be performed at a factory where the acoustic device is manufactured. In some instances, the gas may be introduced at a pressure that corresponds to atmospheric pressure. This gas may be air or it may be a gas of another sort (e.g., nitrogen). In other instances, the gas may be introduced at a pressure that is greater than atmospheric pressure. A greater than atmospheric pressure may be used to help extend the range of pressures that the acoustic device can withstand.

At lock 1020, the acoustic device may be deployed in the wellbore. The acoustic device may collect acoustic data in either a passive or active configuration at block 1030. Finally, at block 1040, collected acoustic data may be analyzed for any purpose that is consistent with wellbore management. This collected data may be processed based on the acoustic device being a directional device.

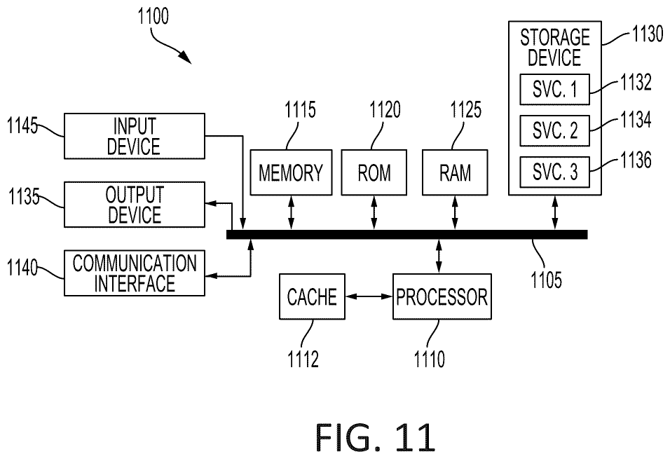

FIG. 11 illustrates an example computing device architecture which can be employed to perform any of the systems and techniques described herein. In some examples, the computing device 1100 architecture can be integrated with tools described herein. The components of the computing device architecture 1100 are shown in electrical communication with each other using a connection 1105, such as a bus. The example computing device architecture 1100 includes a processing unit (CPU or processor) 1110 and a computing device connection 1105 that couples various computing device components including the computing device memory 1115, such as read only memory (ROM) 1120 and random access memory (RAM) 1125, to the processor 1110.

The computing device architecture 1100 can include a cache of high-speed memory connected directly with, in close proximity to, or integrated as part of the processor 1110. The computing device architecture 1100 can copy data from the memory 1115 and/or the storage device 1130 to the cache 1112 for quick access by the processor 1110. In this way, the cache can provide a performance boost that avoids processor 1110 delays while waiting for data. These and other modules can control or be configured to control the processor 1110 to perform various actions. Other computing device memory 1115 may be available for use as well. The memory 1115 can include multiple different types of memory with different performance characteristics. The processor 1110 can include any general-purpose processor and a hardware or software service, such as service 1 1132, service 2 1134, and service 3 1136 stored in storage device 1130, configured to control the processor 1110 as well as a special-purpose processor where software instructions are incorporated into the processor design. The processor 1110 may be a self-contained system, containing multiple cores or processors, a bus, memory controller, cache, etc. A multi-core processor may be symmetric or asymmetric.

To enable user interaction with the computing device architecture 1100, an input device 1145 can represent any number of input mechanisms, such as a microphone for speech, a touch-sensitive screen for gesture or graphical input, keyboard, mouse, motion input, speech and so forth. An output device 1135 can also be one or more of a number of output mechanisms known to those of skill in the art, such as a display, projector, television, speaker device, etc. In some instances, multimodal computing devices can enable a user to provide multiple types of input to communicate with the computing device architecture 1100. The communications interface 1140 can generally govern and manage the user input and computing device output. There is no restriction on operating on any particular hardware arrangement and therefore the basic features here may easily be substituted for improved hardware or firmware arrangements as they are developed.

Storage device 1130 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1125, read only memory (ROM) 1120, and hybrids thereof. The storage device 1130 can include services 1132, 1134, 1136 for controlling the processor 1110. Other hardware or software modules are contemplated. The storage device 1130 can be connected to the computing device connection 1105. In one aspect, a hardware module that performs a particular function can include the software component stored in a computer-readable medium in connection with the necessary hardware components, such as the processor 1110, connection 1105, output device 1135, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings arc, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCS, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Aspects of the present disclosure include:
Aspect 1: An apparatus comprising: an acoustic element arranged within an assembly; one or more chambers disposed along a first set of sides of the assembly that are configured to attenuate acoustic energy according to at least a first coefficient; and one or more acoustic transmission regions disposed within a second set of sides of the assembly that attenuate acoustic energy according to a second coefficient, wherein: the one or more chambers attenuate acoustic energy that propagates from directions that correspond to locations of the first set of sides of the assembly according to the at least first attenuation coefficient, and acoustic energy that propagates from directions that correspond to locations of the second set of sides of the assembly pass through the second set of sides of the assembly toward the acoustic element according to the second coefficient.
Aspect 2: The apparatus of Aspect 1, further comprising a set of geometric features disposed in the one or more chambers, wherein a portion of the geometric features support structural integrity of the one or more chambers when the assembly is exposed to a wellbore environment.
Aspect 3: The apparatus of Aspects 1 or 2, wherein a/the set of geometric features have a shape that corresponds to one or more of a triangle, a trapezoid, a semi-circle, or a curve.
Aspect 4: The apparatus of any of Aspects 1 through 3, wherein the acoustic element transmits pulses of sound energy more efficiently through the assembly along the locations that correspond to the second set of sides of the assembly than the locations of the assembly that correspond to the first set of sides of the assembly.
Aspect 5: The apparatus of any of Aspects 1 through 4, wherein the acoustic element senses the acoustic energy that propagates from the directions that correspond to the locations of the second set of sides of the assembly.
Aspect 6: The apparatus of any of Aspects 1 through 5, wherein the acoustic element transmits pulses of sound energy and receives the acoustic energy via the directions that correspond to the locations of the second set of sides of the assembly.
Aspect 7: The apparatus of any of Aspects 1 through 6, further comprising one or more inputs that provide gas to or that removes gas from the one or more chambers, wherein the one or more chambers are sealed when the assembly is deployed in a wellbore.
Aspect 8: A method comprising: deploying an acoustic device in a wellbore, wherein the acoustic device includes one or more chambers disposed within a first set of sides of the acoustic device that are configured to attenuate acoustic energy according to at least a first coefficient; and collecting data based on the acoustic device being deployed in the wellbore, wherein the data is collected based on acoustic energy propagating through a second set of sides of the acoustic device according to a second coefficient.
Aspect 9: The method of Aspect 8, wherein a set of geometric features are disposed in the one or more chambers, and a portion of the geometric features support structural integrity of the chamber when the acoustic device is exposed to an environment of a/the wellbore.
Aspect 10: The method of Aspect 8 or 9, further comprising transmitting pulses of sound energy from directions that correspond to locations of a/the second set of sides of the acoustic device.
Aspect 11: The method of any of Aspects 8 through 10, further comprising sensing reflections of a/the transmitted pulses the sound energy via the second set of sides of the acoustic device based on the acoustic device being a directional device.
Aspect 12: The method of any of Aspects 8 through 10, further comprising analyzing data associated with the sensed reflections of a/the transmitted pulses of the sound energy.
Aspect 13: The method of any of Aspects 8 through 11, wherein the data is analyzed based on the acoustic device being the directional device.
Aspect 14: The method of any of Aspects 8 through 13, wherein a gas is provided to or removed from the one or more chambers and the one or more chambers are sealed when the acoustic device is deployed in the wellbore.
Aspect 15: A non-transitory computer-readable storage medium comprising having embodied thereon instructions that when executed by one or more processors: collect data based on an acoustic device being deployed in a wellbore, wherein: the data is collected based on one or more chambers of the acoustic device being configured to attenuate acoustic energy according to a first coefficient, the one or more chambers are disposed along a first set of sides of the acoustic device, and the data is collected based on acoustic energy propagating through a second set of sides of the acoustic device according to a second coefficient.
Aspect 16: The non-transitory computer-readable storage medium of Aspect 15, wherein a set of geometric features are disposed in the one or more chambers, and a portion of the geometric features support structural integrity of the one or more chambers when the acoustic device is exposed to an environment of the wellbore.
Aspect 17: The non-transitory computer-readable storage medium of Aspect 15 or 16, wherein the one or more processors execute the instructions to control transmission of pulses of sound energy from a/the second set of sides of the acoustic device.
Aspect 18: The non-transitory computer-readable storage medium of any of Aspects 15 through 17, wherein the one or more processors execute the instructions to collect data that corresponds to sensed reflections of the transmitted pulses of the sound energy via a/the second set of sides of the acoustic device based on the acoustic device being a directional device.
Aspect 19: The non-transitory computer-readable storage medium of any of Aspects 15 through 18, wherein the one or more processors execute the instructions to analyze data associated with the sensed reflections of the transmitted pulses of a/the sound energy.
Aspect 20: The non-transitory computer-readable storage medium of any of Aspects 19 through 20, wherein the data is analyzed based on the acoustic device being a directional device.

What is claimed is:

1. An apparatus comprising:
an acoustic element arranged within an assembly;
one or more chambers disposed along a first set of sides of the assembly that are configured to attenuate acoustic energy according to at least a first coefficient; and
one or more acoustic transmission regions disposed within a second set of sides of the assembly that attenuate acoustic energy according to a second coefficient, wherein:
the one or more chambers attenuate acoustic energy that propagates from directions that correspond to locations of the first set of sides of the assembly according to the at least first attenuation coefficient, and
acoustic energy that propagates from directions that correspond to locations of the second set of sides of the assembly pass through the second set of sides of the assembly toward the acoustic element according to the second coefficient.

2. The apparatus of claim 1, further comprising:
a set of geometric features disposed in the one or more chambers, wherein a portion of the geometric features support structural integrity of the one or more chambers when the assembly is exposed to a wellbore environment.

3. The apparatus of claim 2, wherein the set of geometric features have a shape that corresponds to one or more of a triangle, a trapezoid, a semi-circle, or a curve.

4. The apparatus of claim 1, wherein the acoustic element transmits pulses of sound energy more efficiently through the assembly along the locations that correspond to the second set of sides of the assembly than the locations of the assembly that correspond to the first set of sides of the assembly.

5. The apparatus of claim 1, wherein the acoustic element senses the acoustic energy that propagates from the directions that correspond to the locations of the second set of sides of the assembly.

6. The apparatus of claim 1, wherein the acoustic element transmits pulses of sound energy and receives the acoustic energy via the directions that correspond to the locations of the second set of sides of the assembly.

7. The apparatus of claim 1, further comprising one or more inputs that provide gas to or that removes gas from the one or more chambers, wherein the one or more chambers are sealed when the assembly is deployed in a wellbore.

8. A method comprising:
deploying an acoustic device in a wellbore, wherein the acoustic device includes one or more chambers disposed within a first set of sides of the acoustic device that are configured to attenuate acoustic energy according to at least a first coefficient; and
collecting data based on the acoustic device being deployed in the wellbore, wherein the data is collected based on acoustic energy propagating through a second set of sides of the acoustic device according to a second coefficient.

9. The method of claim 8, wherein a set of geometric features are disposed in the one or more chambers, and a portion of the geometric features support structural integrity of the chamber when the acoustic device is exposed to an environment of the wellbore.

10. The method of claim 8, further comprising:
transmitting pulses of sound energy from directions that correspond to locations of the second set of sides of the acoustic device.

11. The method of claim 10, further comprising:
sensing reflections of the transmitted pulses the sound energy via the second set of sides of the acoustic device based on the acoustic device being a directional device.

12. The method of claim 11, further comprising:
analyzing data associated with the sensed reflections of the transmitted pulses of the sound energy.

13. The method of claim 12, wherein the data is analyzed based on the acoustic device being the directional device.

14. The method of claim 8, wherein a gas is provided to or removed from the one or more chambers and the one or more chambers are sealed when the acoustic device is deployed in the wellbore.

15. A non-transitory computer-readable storage medium comprising having embodied thereon instructions that when executed by one or more processors:
collect data based on an acoustic device being deployed in a wellbore, wherein:
the data is collected based on one or more chambers of the acoustic device being configured to attenuate acoustic energy according to a first coefficient,
the one or more chambers are disposed along a first set of sides of the acoustic device, and
the data is collected based on acoustic energy propagating through a second set of sides of the acoustic device according to a second coefficient.

16. The non-transitory computer-readable storage medium of claim 15, wherein a set of geometric features are disposed in the one or more chambers, and a portion of the geometric features support structural integrity of the one or more chambers when the acoustic device is exposed to an environment of the wellbore.

17. The non-transitory computer-readable storage medium of claim 15, wherein the one or more processors execute the instructions to:
control transmission of pulses of sound energy from the second set of sides of the acoustic device.

18. The non-transitory computer-readable storage medium of claim 17, wherein the one or more processors execute the instructions to:
collect data that corresponds to sensed reflections of the transmitted pulses of the sound energy via the second set of sides of the acoustic device based on the acoustic device being a directional device.

19. The non-transitory computer-readable storage medium of claim 18, wherein the one or more processors execute the instructions to:
analyze data associated with the sensed reflections of the transmitted pulses of the sound energy.

20. The non-transitory computer-readable storage medium of claim 19, wherein the data is analyzed based on the acoustic device being a directional device.
